(19) United States
(12) Patent Application Publication
(10) Pub. No.: US 2023/0070003 A1
(43) Pub. Date: Mar. 9, 2023

(54) DETERMINING LOCATIONS OF OBJECTS IN COMMUNICATION SYSTEMS

(71) Applicant: NOKIA TECHNOLOGIES OY, Espoo (FI)

(72) Inventors: Chunhua GENG, Basking Ridge, NJ (US); Howard HUANG, New York, NY (US); Jack LANGERMAN, New York, NY (US)

(21) Appl. No.: 17/795,068

(22) PCT Filed: Jan. 27, 2020
(86) PCT No.: PCT/EP2020/051896

§ 371 Date: Jul. 25, 2022

(51) Int. Cl. H04B 7/06

(52) U.S. Cl. CPC H04B 7/0626

(57) ABSTRACT

An apparatus, method and computer program is described comprising: providing a plurality of processed channel state information data to separate inputs of a multiple- input-multiple-output autoencoder, wherein each channel state information data of the plurality relates to communications between a user device and one of a plurality of communication nodes in communication with said user device; and generating a co-ordinate code for the user device using said autoencoder.

### FIELD

The present specification relates to determining locations of objects in communication systems.

### BACKGROUND

For many reasons, it may be desired to know the position of a device, such as a user device, in space (e.g. an absolute position or relative position). There remains a need for further developments in this field.

### SUMMARY

In a first aspect, this specification describes an apparatus comprising means for performing: providing a plurality of processed channel state information data to separate inputs of a multiple-input-multiple-output autoencoder (such as a convolutional autoencoder), wherein each channel state information data of the plurality relates to communications between a user device and one of a plurality of communication nodes (e.g. base stations) in communication with said user device; and generating a co-ordinate code for the user device using said autoencoder. The autoencoder may, for example, be pre-trained (e.g. using unsupervised learning).

In some example embodiments, the means are further configured to perform: processing said channel state information to generate said plurality of processed channel state information data. Processing said channel state information data may include generating moment matrices (e.g. second order moment matrices) of said channel state information data. Alternatively, or in addition, processing said channel state information data may include normalising said data.

In some example embodiments, the means are further configured to provide: determining the channel state information data. Determining the channel state information data may be carried out at each of the respective communication nodes.

The co-ordinate code may be provided by a fully connected layer of the autoencoder.

In some example embodiments, the means are further configured to provide: updating trainable parameters of said autoencoder based on at least some of the plurality of processed channel state information data.

The said means may comprise: at least one processor; and at least one memory including computer program code, the at least one memory and the computer program configured, with the at least one processor, to cause the performance of the apparatus.

In a second aspect, this specification describes an apparatus comprising means for performing: providing a plurality of processed channel state information data to separate inputs of a multiple-input-multiple-output convolutional autoencoder, wherein each channel state information data of the plurality relates to communications between one of a plurality of user devices and one of a plurality of communication nodes (e.g. base stations); and updating trainable parameters of said autoencoder based on at least some of the plurality of processed channel state information data (e.g. using unsupervised learning). The trainable parameters may be updated periodically. Alternatively, or in addition, the trainable parameters may be updated in accordance with a performance metric

In some example embodiments, the means are further configured to perform: processing said channel state information data to generate said plurality of processed channel state information data. The channel state information data may be processed by generated moment matrices and/or normalising said data.

In some example embodiments, the means are further configured to provide: determining the channel state information data. The channel state information data may be determined at each of the respective communication nodes.

The said means may comprise: at least one processor; and at least one memory including computer program code, the at least one memory and the computer program configured, with the at least one processor, to cause the performance of the apparatus.

In a third aspect, this specification describes a method comprising: providing a plurality of processed channel state information data to separate inputs of a multiple-input-multiple-output autoencoder (such as a convolutional autoencoder), wherein each channel state information data of the plurality relates to communications between a user device and one of a plurality of communication nodes (e.g. base stations) in communication with said user device; and generating a co-ordinate code for the user device using said autoencoder. The autoencoder may, for example, be pre-trained (e.g. using unsupervised learning).

Some example embodiments further comprise: processing said channel state information to generate said plurality of processed channel state information data. Processing said channel state information data may include generating moment matrices (e.g. second order moment matrices) of said channel state information data. Alternatively, or in addition, processing said channel state information data may include normalising said data.

Some example embodiments further comprise: determining the channel state information data. Determining the channel state information data may be carried out at each of the respective communication nodes.

Some example embodiments further comprise: updating trainable parameters of said autoencoder based on at least some of the plurality of processed channel state information data.

In a fourth aspect, this specification describes a method comprising: providing a plurality of processed channel state information data to separate inputs of a multiple-input-multiple-output convolutional autoencoder, wherein each channel state information data of the plurality relates to communications between one of a plurality of user devices and one of a plurality of communication nodes (e.g. base stations); and updating trainable parameters of said autoencoder (e.g. using unsupervised learning) based on at least some of the plurality of processed channel state information data.

Some example embodiments further comprise: processing said channel state information data to generate said plurality of processed channel state information data. The channel state information data may be processed by generated moment matrices and/or normalising said data.

Some example embodiments further comprise: determining the channel state information data. The channel state information data may be determined at each of the respective communication nodes.

In a fifth aspect, this specification describes an apparatus configured to perform any method as described with reference to the third or fourth aspects.

In a sixth aspect, this specification describes computer-readable instructions which, when executed by computing apparatus, cause the computing apparatus to perform any method as described with reference to the third or fourth aspects.

In a seventh aspect, this specification describes a computer program comprising instructions for causing an apparatus to perform at least the following: providing a plurality of processed channel state information data to separate inputs of a multiple-input-multiple-output autoencoder (such as a convolutional autoencoder), wherein each channel state information data of the plurality relates to communications between a user device and one of a plurality of communication nodes (e.g. base stations) in communication with said user device; and generating a co-ordinate code for the user device using said autoencoder.

In an eighth aspect, this specification describes a computer program comprising instructions for causing an apparatus to perform at least the following: providing a plurality of processed channel state information data to separate inputs of a multiple-input-multiple-output convolutional autoencoder, wherein each channel state information data of the plurality relates to communications between one of a plurality of user devices and one of a plurality of communication nodes (e.g. base stations); and updating trainable parameters of said autoencoder (e.g. using unsupervised learning) based on at least some of the plurality of processed channel state information data.

In a ninth aspect, this specification describes a computer-readable medium (such as a non-transitory computer-readable medium) comprising program instructions stored thereon for performing at least the following: providing a plurality of processed channel state information data to separate inputs of a multiple-input-multiple-output autoencoder (such as a convolutional autoencoder), wherein each channel state information data of the plurality relates to communications between a user device and one of a plurality of communication nodes (e.g. base stations) in communication with said user device; and generating a co-ordinate code for the user device using said autoencoder.

In a tenth aspect, this specification describes a computer-readable medium (such as a non-transitory computer-readable medium) comprising program instructions stored thereon for performing at least the following: providing a plurality of processed channel state information data to separate inputs of a multiple-input-multiple-output convolutional autoencoder, wherein each channel state information data of the plurality relates to communications between one of a plurality of user devices and one of a plurality of communication nodes (e.g. base stations); and updating trainable parameters of said autoencoder (e.g. using unsupervised learning) based on at least some of the plurality of processed channel state information data.

In an eleventh aspect, this specification describes an apparatus comprising: at least one processor; and at least one memory including computer program code which, when executed by the at least one processor, causes the apparatus to: provide a plurality of processed channel state information data to separate inputs of a multiple-input-multiple-output autoencoder (such as a convolutional autoencoder), wherein each channel state information data of the plurality relates to communications between a user device and one of a plurality of communication nodes (e.g. base stations) in communication with said user device; and generate a co-ordinate code for the user device using said autoencoder.

In an eleventh aspect, this specification describes an apparatus comprising: at least one processor; and at least one memory including computer program code which, when executed by the at least one processor, causes the apparatus to: provide a plurality of processed channel state information data to separate inputs of a multiple-input-multiple-output convolutional autoencoder, wherein each channel state information data of the plurality relates to communications between one of a plurality of user devices and one of a plurality of communication nodes (e.g. base stations); and update trainable parameters of said autoencoder (e.g. using unsupervised learning) based on at least some of the plurality of processed channel state information data.

In a thirteenth aspect, this specification describes an apparatus comprising: means (such as a first processor) for providing a plurality of processed channel state information data to separate inputs of a multiple-input-multiple-output autoencoder (such as a convolutional autoencoder), wherein each channel state information data of the plurality relates to communications between a user device and one of a plurality of communication nodes (e.g. base stations) in communication with said user device; and means (such as autoencoder or a machine learning module) for generating a co-ordinate code for the user device using said autoencoder.

In a fourteenth aspect, this specification describes an apparatus comprising: means (such as a first processor) for providing a plurality of processed channel state information data to separate inputs of a multiple-input-multiple-output convolutional autoencoder, wherein each channel state information data of the plurality relates to communications between one of a plurality of user devices and one of a plurality of communication nodes (e.g. base stations); and means (such as control module) for updating trainable parameters of said autoencoder (e.g. using unsupervised learning) based on at least some of the plurality of processed channel state information data.

### BRIEF DESCRIPTION OF THE DRAWINGS

Example embodiments will now be described, by way of non-limiting examples, with reference to the following schematic drawings, in which:

FIGS. 1 and 2 are block diagrams of systems in accordance with example embodiments;

FIG. 3 is a flow chart showing an algorithm in accordance with an example embodiment;

FIG. 4 is a block diagram of a system in accordance with an example embodiment;

FIG. 5 is a flow chart showing an algorithm in accordance with an example embodiment;

FIG. 6 is a block diagram of an autoencoder in accordance with an example embodiment;

FIG. 7 is a flow chart showing an algorithm in accordance with an example embodiment;

FIG. 8 is a block diagram of a neural network that may be used in some example embodiments;

FIG. 9 is a block diagram of a components of a system in accordance with an example embodiment; and

FIGS. 10A and 10B show tangible media, respectively a removable memory unit and a compact disc (CD) storing computer-readable code which when run by a computer perform operations according to embodiments.

### DETAILED DESCRIPTION

The scope of protection sought for various embodiments of the invention is set out by the independent claims. The embodiments and features, if any, described in the specification that do not fall under the scope of the independent claims are to be interpreted as examples useful for understanding various embodiments of the invention.

In the description and drawings, like reference numerals refer to like elements throughout.

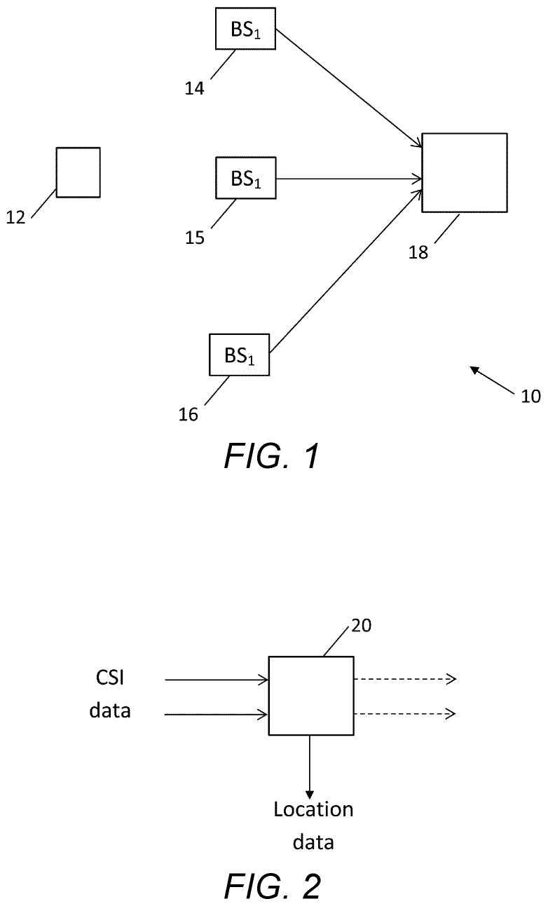

FIG. 1 is a block diagram of a system, indicated generally by the reference numeral 10, in accordance with an example embodiment. The system 10 includes a user device 12, a first base station 14, a second base station 15, a third base station 16 and a processor 18. The processor 18 may form part of a communication system.

For many reasons, it may be desired to know the position of the user device 12, either in absolute terms or in relative terms (e.g. relative to the position of one or more of the base stations 14 to 16 or relative to the positions of other user devices). It should be noted that although the embodiments described herein generally relate to user devices and base stations, the principles can be applied to any device in communication with any suitable communication node.

For many applications, the absolute physical locations of user devices are not necessary, but only relative positioning information (e.g., the positional relationship between different user devices) is needed. Examples of such applications include geo-fencing, user clustering, user tracking, network planning, semantic localization, cell hand-over etc.

The base stations 14 to 16 may each collect channel state information (CSI) measurements for communications between the user device 12 and the respective base station. In many communication systems, such CSI data is readily available. For example, consider a 5G system where 1024 user equipments (UEs) communicate on an uplink with a base station (e.g. gNodeB), and the signal is also received by seven other nearby base stations (or by seven dedicated location measurement units). CSI information could be obtained per user, antenna link, and per subcarrier. For example, for such a 5G cellular network consisting of 8 base stations and 1024 users, where each base has 32 antennas and 128 subcarriers, the dimensionality of the CSI would be 8×1024×32×128=33,554,432.

The richness of such CSI data provides plentiful information about network states, such as the spatial distribution and trajectories of the devices, which are useful for accurate positioning. On the other hand, the massive amount of CSI data can pose challenges for data processing.

FIG. 2 is a block diagram of a system 20 for providing an estimate of a position of a user device, in accordance with an example embodiment. The system 20 includes an input for receiving channel state data (such as channel state information) and an output for providing location data. By way of example, the system 20 may be provided as part of the processor 18 of the system 10 described above. On receipt of channel state data relating to communications between a device (such as the user device 12) and each of the base stations 14 to 16, the system 20 seeks to provide an estimate of the location of that device.

As described in detail below, the system 20 may include an autoencoder. Autoencoders are neural networks capable of learning efficient representations of the input data, or “codes”, often without supervision. Adding constraints to the networks, e.g., limiting the size of internal representation (i.e., the dimension of the code), can be used to force the autoencoder to learn efficient ways of representing the data. In a relative positioning problem, we may limit the dimension of the final code to be two (for 2D positioning) or three (for 3D positioning), such that the codes represent the relative positions in a low-dimensional representation space. Thus, in some example embodiments, it may be assumed that if two devices are close in physical space, their codes (learned from the CSI) will be close in the low-dimensional representation space, and vice versa. Note that an autoencoder includes two parts (an encoder and a decoder). After training the autoencoder, we only need the encoder for the purpose of positioning (the decoder may be used for other applications, e.g., CSI predication for users with known locations). The system 20 may, in some example embodiments, include only the encoder part of the autoencoder.

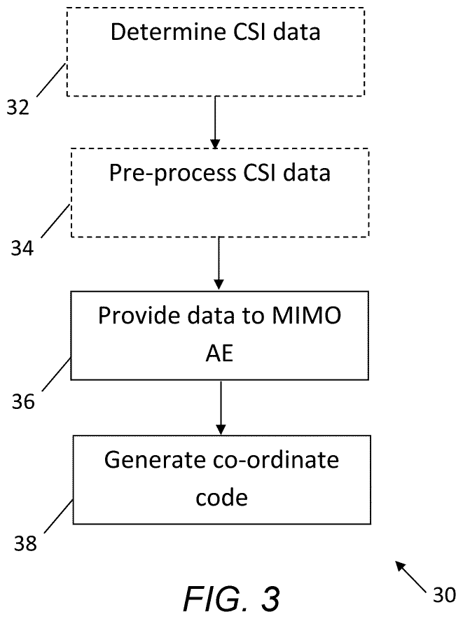

FIG. 3 is a flow chart showing an algorithm, indicated generally by the reference numeral 30, in accordance with an example embodiment.

The algorithm 30 starts at operation 32 where channel state information (CSI) data is determined. At operation 34, the CSI data may be pre-processed in some way to generate a plurality of processed channel state information data (e.g. by generating moment matrices and/or normalising the data, as discussed in detail below).

By way of example, CSI data relating to the user device 12 may be obtained from each of the first to third base stations 14 to 16 of the system 10 described above, such that a plurality of channel state data are determined, wherein each channel state information data of the plurality relates to communications between the user device 12 and one of the plurality of base station in communication with the respective user device.

At operation 36, the plurality of processed channel state information data are provided to separate inputs of a multiple-input-multiple-output (MIMO) autoencoder (AE). At operation 38, the MIMO autoencoder is used to generate a co-ordinate code for the user device. The co-ordinate code is related to the position of that device, as discussed further below. By way of example, processed CSI data may be provided to the system 20, which system generates location data in the form of the co-ordinate code referred to above.

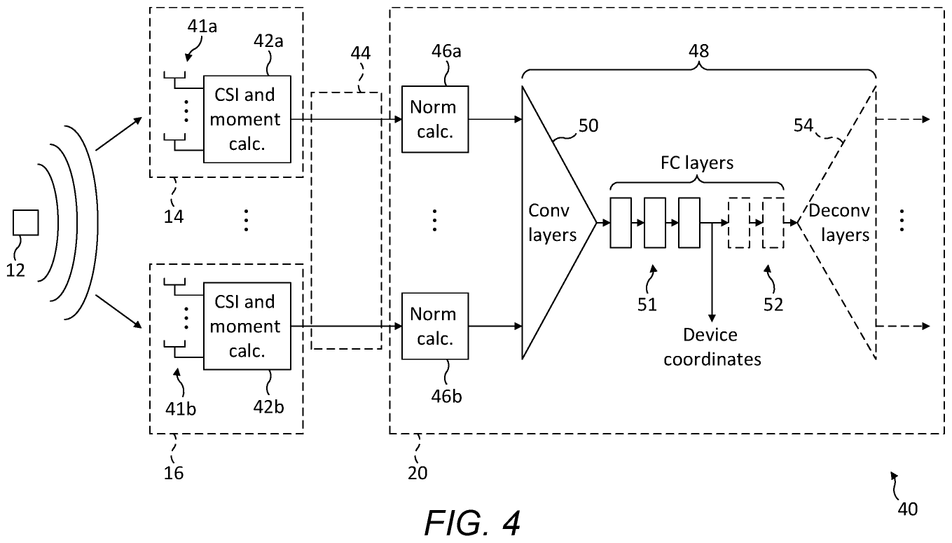

FIG. 4 is a block diagram of a system, indicated generally by the reference numeral 40, in accordance with an example embodiment. The system 40 may be used to implement the algorithm 30 described above.

The system 40 includes the user device 12, the first base station 14 and the third base station 16 of the system 10 described above. The first and third base stations 14 and 16 are two of a plurality of communication nodes that may be in communication with the user device 12 (and may also be in communication with many other user devices, not shown). The system 40 further comprises the system 20 described above for providing an estimate of a position of the user device 12.

The user device 12 transmits signals which are received at the plurality of base stations (including the first base station 14 and the third base station 16 shown in the system 40). At each base station, the received signals are processed to estimate the CSI.

The first base station 14 includes an antenna array indicated generally by the reference numeral 41a and a processor 42a. Similarly, the third base station 16 comprises an antenna array 41b and a processor 42b.

The processors 42a and 42b (and similar processors at other base stations of the plurality) generate moment matrices from the CSI estimates. The moment matrices are transmitted to the system 20 as a set of data 44 (e.g. using a standardized protocol).

The system 20 comprises a first processor 46a, a second processor 46b and a MIMO autoencoder 48.

At the system 20, the moment matrices of the data 44 are normalized by the first processor 46a and the second processor 46b to generate normalised moment matrices. Of course, further processors could be provided to normalise data from other base stations. Moreover, it is not essential to provide separate processors to normalise the moment matrices relating to each of the base stations.

The outputs of the processors 46a and 46b are provided as inputs to the MIMO autoencoder 48.

The autoencoder 48 comprises first convolutional layers 50, a first set of fully connected (FC) layers 51, a second set of fully connected (FC) layers 52 and first deconvolutional layers 54. The first convolutional layers 50 and the first FC layers 51 form an encoder portion of the autoencoder 48. Similarly, the second FC layers 52 and the first deconvolutional layers 54 form a decoder portion of the autoencoder 48. The autoencoder is trained (and may be pre-trained) such that the outputs of the first deconvolutional layers 54 match (or closely match) the inputs to the first convolutional layers 51.

Coordinate codes for the user device 12 can be extracted from the learned latent codes produced by the first fully connected (FC) layers 51 of the encoder portion of the autoencoder 48. The decoder layers that follow are used for training the convolutional autoencoder but not used during the localization procedure (i.e., inference). Thus, in an example implementation of the system 40, the decoder portion of the autoencoder may be omitted (and hence those portions are shown in dotted form in the system 40).

Thus, the encoder portion of the MIMO autoencoder 48 may be used to map the moment matrices (generated from the CSI) to coordinates of the corresponding devices (codes) in an arbitrary coordinate system (which may, for example, be two- or three-dimensional). Although such device co-ordinate codes are not necessarily aligned with any physical coordinate system, the training of the autoencoder 48 seeks to preserve the property that two devices which are physically proximate in the real-world system will have codes that are close in the learned representation space.

The example embodiments described herein therefore seek to include simple pre-processing of raw CSI measurements with the use of convolutional autoencoder technology to fuse CSI measurements from multiple base stations.

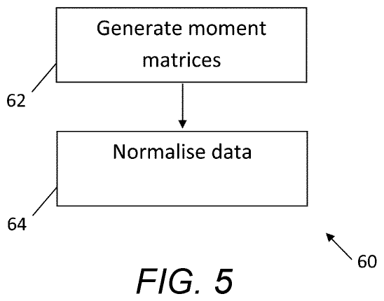

FIG. 5 is a flow chart showing an algorithm, indicated generally by the reference numeral 60, in accordance with an example embodiment. The algorithm 60 is an example implementation of the processing operation 34 of the algorithm 30 described above.

The algorithm 60 starts at operation 62, where moment matrices are generated by processing the channel state information data determined at the base stations or communication nodes of the communication system. The operation 62 may be implemented using the processors 42a and 42b described above, but this is not essential to all example embodiments. For example, the operation 62 may be implemented at the system 20, or may be implemented elsewhere (for example at a remote server, such as in the cloud).

At operation 64, the moment matrices are normalised to generate normalise moment matrices. The operation 64 may be implemented using the processors 46a and 46b described above, but this is not essential to all example embodiments. For example, the operation 64 may be implemented at the various base stations (or communication nodes), or may be implemented elsewhere (for example at a remote server, such as in the cloud).

The outputs of the operation 64 may be provided to the MIMO autoencoder 48 and used to generated co-ordinate codes, as discussed above with reference to operations 36 and 38 of the algorithm 30.

Details of some example embodiments have been described above. Further details, including mathematical details, are provided below.

Consider a wireless network with B base stations (such as the base stations 14, 15 and 16 described above), where each of the base stations includes N antennas (such as the antenna arrays 42a and 42b) and M subcarriers. Assume that there are U user devices (such as the user device 12) and each user device has a single antenna.

As described above, at operation 32 of the algorithm 30, CSI data is determined. This may be implemented at each time slot t, by each base station b ϵ {1, 2, . . . , B} extracting the CSI matrix of the u-th user device H_{b,u,t} ϵ [symbol] ^{N×M} based on the corresponding received data.

At operation 34, the CSI data is pre-processed. As described above, the pre-processing may have two parts: calculating moment matrices (operation 62 of the algorithm 60) and normalising the moment matrices (operation 64 of the algorithm 60).

In one example implementation, calculating moment matrices comprises calculating the second order statistical moment for the CSI measurements of each base station, for example:

$${\tilde{ℍ}}_{u}^{b} = \frac{1}{T} {\sum }_{t = 1}^{T} {H}_{b , u , t} {H}_{b , u , t}^{H} \qquad ( 1 )$$

where T is the number of time slots, which can be taken as a small value (e.g. 10 or less).

Normalising the moment matrices may involve normalising the derived CSI moments to make sure that the input amplitude is between −1 and 1, i.e.:

$${u}_{b}^{} = \frac{{{˜}^{}}_{u}^{b}}{max \{ 𝕄𝔸𝕏 \{ \vert \{ \} \vert \} , 𝕄𝔸𝕏 \{ \vert \{ \} \vert \} \}} \qquad ( 2 )$$

where [symbol] is the collection matrix of [symbol] ᵤ^{b} with ∀u ϵ{1, 2, . . . , U} and ∀b ϵ{1, 2, . . . , B}, i.e.:

$$= [ \begin{matrix}{{˜}^{}}_{1}^{1} & {{˜}^{}}_{2}^{1} & … & {{\sim}^{}}_{U}^{1} \\ {{\sim}^{}}_{1}^{2} & {{\sim}^{}}_{2}^{2} & … & {{\sim}^{}}_{U}^{2} \\ ⋮ & & ⋱ & ⋮ \\ {{\sim}^{}}_{1}^{B} & {{\sim}^{}}_{2}^{B} & … & {{\sim}^{}}_{U}^{B}\end{matrix} ] \qquad ( 3 )$$

The operations [symbol] {.}, [symbol] {.} and |.| take the entry-wise real part, imaginary part and absolute value of the input matrix respectively and [symbol] {.} takes the maximal entry of the input matrix.

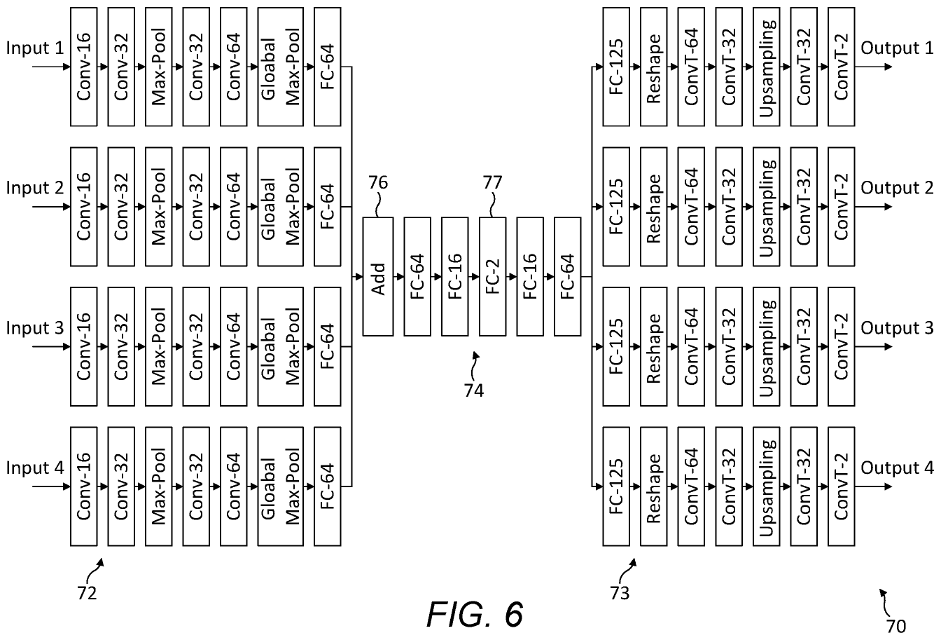

FIG. 6 is a block diagram of an autoencoder, indicated generally by the reference numeral 70, in accordance with an example embodiment. The autoencoder 70 is a convolutional encoder and is an example implementation of the autoencoder 48 in a system having four base stations (i.e. B=4), each having 16 antennas.

The autoencoder 70 comprises first convolutional layers 72 (similar to the first convolution layers 50 of the autoencoder 48), first deconvolutional layers 73 (similar to the first deconvolutional layers 54 of the autoencoder 48) and fully-connected (FC) layers 74 (similar to the combination of the first and second FC layers 51 and 52 of the autoencoder 48).

In the present example, after the pre-processing steps (of operation 34) have been completed, each of the inputs matrices has a fixed size of 16×16×2. Here, the channel number equals 2 since the normalise CSI moment has both real and imaginary parts (i.e. the real and imaginary parts of the CSI moment are fed into two different channels).

In the autoencoder 70, “Conv-X” refers to a 2D convolutional layer with X output filters, “ConvT-X” refers to a 2D deconvolutional layer with X output filters, and “FC-X” refers to fully connected layers with X neurons.

In the autoencoder 70, the FC layer 74 includes a fully connected FC-2 layer 77 that outputs the co-ordinate code used as the relative position information for the relevant user device.

Also of interest in the FC layer 74 of the autoencoder 70 is the add layer 76, which fuses the outputs of the channels of the first convolutional layers 72.

In an example implementation, in the first convolutional layers 72 and first deconvolutional layers 73, the filter size is 2×2, the stride is set to 1, and valid padding is used. Max-pooling is performed over the 2×2 window, with stride 1. For the upsampling layers, the upsampling factor equals 2, for both rows and columns. The “Reshape” layer in the autoencoder 70 reshapes the input to a tensor with size 5×5×5. Regarding the non-linear activations, the first and last hidden layers use tanh, and all other layers use ReLU. Denoting the trainable weights in the “FC−2” layer 77 by W_{fc2}, the loss function used during training is defined as:

$$L = \frac{1}{2 U} {{\sum }^{B}}_{b = 1} {{\sum }_{u = 1}}^{U} {‖ {ℍ}_{u}^{b} - {\hat{ℍ}}_{u}^{b} ‖}_{2}^{2} + \frac{β}{2} {‖ {W}_{fc 2} ‖}_{F}^{2} \qquad ( 4 )$$

Of course, many alternative implementations of the autoencoder 70 are possible and will be apparent to those of ordinary skill in the art.

The autoencoder 70 can be used to implement a solution in which CSI data from multiple base stations can be considered for generating position information (e.g. relative position information or co-ordinate codes) for a user device in communication with the multiple base stations. The convolutional neural network (CNN) structure of the autoencoder 70 is used to exploit the underlying local structure of CSI measurements. Relatively simple pre-processing steps are proposed to pre-process the raw CSI measurements. Further, as discussed below, end-to-end training can be used to training the autoencoder 70 for high performance.

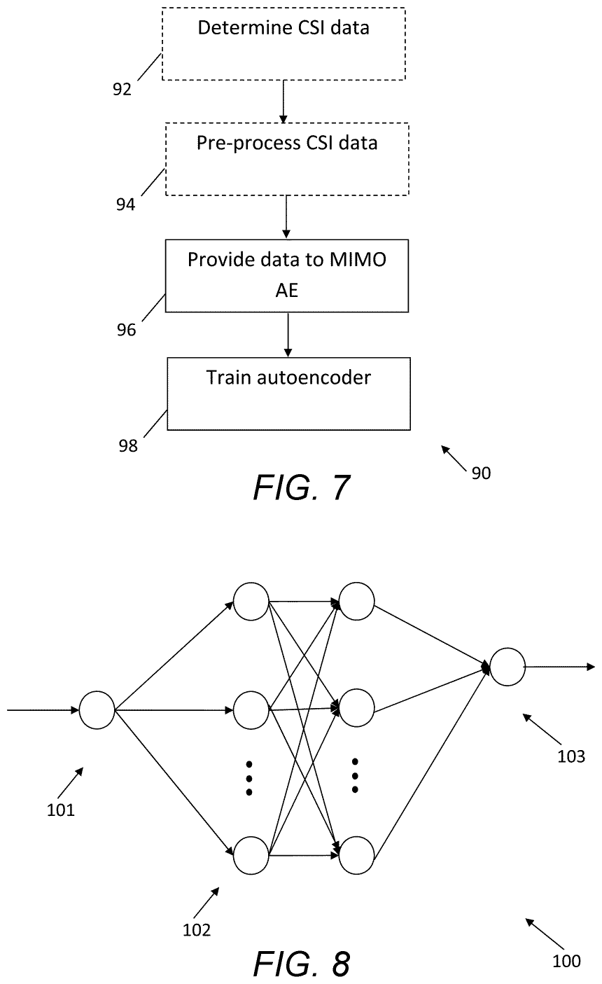

FIG. 7 is a flow chart showing an algorithm, indicated generally by the reference numeral 90, in accordance with an example embodiment.

The algorithm 90 starts at operation 92 where channel state information (CSI) data is determined (and is therefore similar to the operation 32 described above). At operation 94 (which is similar to the operation 34 described above), the CSI data may be pre-processed in some way to generate a plurality of processed channel state information data (e.g. by generating moment matrices and/or normalising the data, as discussed in detail above).

At operation 96, the plurality of processed channel state information data are provided to separate inputs of a multiple-input-multiple-output autoencoder, such as the autoencoders 48 and 70 described above. At operation 98, the MIMO autoencoder is trained by updating trainable parameters of said autoencoder based on at least some of the plurality of processed channel state information data.

The trainable parameters of the autoencoder may be updated periodically. The trainable parameters of the autoencoder may be updated in accordance with a performance metric (such as a loss function).

FIG. 8 is a block diagram, of a neural network, indicated generally by the reference numeral 100, that may be used in some example embodiments. For example, parts of the autoencoders 48 and 70 may be a machine learning model that may be implemented using a neural network, such as the neural network 100.

The neural network 100 comprises an input layer 101, one or more hidden layers 102, and an output layer 103. During the usage of the neural network 100, at the input layer 101, input such as (processed) channel state data may be received. The hidden layers 102 may comprise a plurality of hidden nodes, where the processing may be performed based on the received inputs (e.g. channel state data). At the output layer 103, one or more outputs (e.g. location data) relating to the input may be provided.

The neural network 100 may be trained during use, such that outputs of the autoencoder match the inputs. The neural network 100 may be trained offline (e.g. pre-trained before starting the use of the model) and/or may be trained online (e.g. training may continue in use, and the neural network 100 may be updated based on new data).

The autoencoders described herein may be cloud-implemented autoencoders (e.g. Evolved Serving Mobile Location Center or E-SMLC in LTE networks). When training a deep neural network implementing such autoencoders, multiple base stations collect raw CSI measurements from different users. The pre-processing operations described above (e.g. operations 34, 62, 64 or 94) may be implemented locally at a base station or elsewhere, such as in the cloud). For locally implemented pre-processing, less bandwidth is typically needed for data transmission, but standardisation may be required since the data transmitted from the base stations to the cloud are no longer raw CSI measurements, but the CSI moment matrices (which matrices may be normalised). For cloud implemented pre-processing, after pre-processing all the raw CSI measurements, the pre-processed data are fed into the neural network for training.

During training, the neural network seeks to copy the autoencoder inputs to the outputs. Thus, no ground truth labels on the user device positions are required for training. Thus, unsupervised learning can be implemented. When a loss function (such as the loss function given in equation (4) above) is below a defined threshold, the training may end.

The trained neural network weights for the autoencoder can be stored in the cloud for is future use. The training phase as described above (e.g. the algorithm 90) may be invoked periodically (e.g. every few hours or every few days), for example in case the surrounding environment changes significantly. Other arrangements for invoking further training are also possible. For example, in the event that CSI data between the base stations and one or more dedicated beacons with fixed positions changes significantly, this may indicate that an environment has changed, thereby trigger updating of the training.

As discussed above, after training, the outputs of the FC-2 layer can be used as relative positions for the user device in the learned representation space (e.g. a co-ordinate code). When estimating positions of new user device, the pre-processed CSI moment matrices may be provided as inputs to the trained network and the outputs of the FC-2 layer used as estimation results.

A number of variants to the embodiments described above are possible. For example, it is possible to fine tune the hyperparameters of the autoencoder, e.g., the number of hidden layers, the number of filters in each convolution layer, the shape of the filters, the batch size for training, the activation function at each layer, etc., to further improve the performance.

Whilst the embodiments described above relate to relative localization, the techniques described herein could be extended for absolute localization or device-free sensing. For example, if some of the positions of user devices are known, it may be possible to learn absolute user device positions via a supervised or semi-supervised learning approach.

The possible applications of the principles described herein are abundant, including user clustering, user tracking, network planning, cell hand-over, link adaption, beam prediction for millimeter wave and terahertz systems, and other automatic network radio resource management (RRM) functions.

One specific example application is In-Region Location Verification (IRLV) or Geofencing. In the IRLV task, it may be desired to identify if a user device is inside a region of interest (ROI) or not. The developed neural network could be used to address this problem. For example, when collecting training data, CSI measurements could be collected for instances when the user device is inside ROI (note that for these training data we do not need the accurate user positions, instead we only require that the user is inside ROI). As the proposed autoencoder attempts to copy the inputs to its outputs, in the testing phase, only CSI with features similar to those of the training set will be reconstructed with a smaller error. As a result, when testing, the CSI measurements collected inside ROI will have smaller reconstruction errors, while those collected outside ROI will have larger reconstruction errors. We could set a threshold for the reconstruction error to estimate if a user is inside ROI or not.

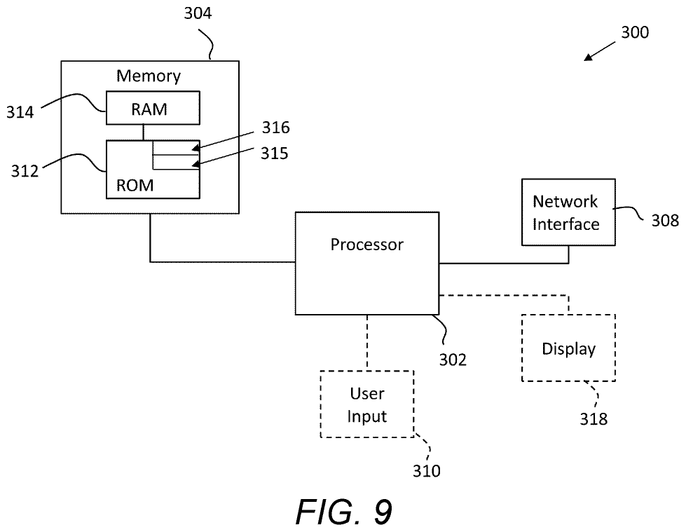

For completeness, FIG. 9 is a schematic diagram of components of one or more of the example embodiments described previously, which hereafter are referred to generically as a processing system 300. The processing system 300 may, for example, be the apparatus referred to in the claims below.

The processing system 300 may comprise one or more of: a processor 302, a memory 304 closely coupled to the processor and comprised of a RAM 314 and a ROM 312, a user input 310 (such as a touch screen input, hardware keys and/or a voice input mechanism) and a display 318 (at least some of those components may be omitted in some example embodiments). The processing system 300 may comprise one or more network/apparatus interfaces 308 for connection to a network/apparatus, e.g. a modem which may be wired or wireless. The interface 308 may also operate as a connection to other apparatus such as device/apparatus which is not network side apparatus. Thus, direct connection between devices/apparatus without network participation is possible.

The processor 302 is connected to each of the other components in order to control operation thereof.

The memory 304 may comprise a non-volatile memory, such as a hard disk drive (HDD) or a solid state drive (SSD). The ROM 312 of the memory 304 stores, amongst other things, an operating system 315 and may store software applications 316. The RAM 314 of the memory 304 is used by the processor 302 for the temporary storage of data. The operating system 315 may contain code which, when executed by the processor implements aspects of the algorithms 30, 60 and 90 described above. Note that in the case of small device/apparatus the memory can be most suitable for small size usage i.e. not always a hard disk drive (HDD) or a solid state drive (SSD) is used. The memory 304 may include computer program code, such that the at least one memory 304 and the computer program may be configured, with the at least one processor 302, may cause the performance of the apparatus.

The processor 302 may take any suitable form. For instance, it may be a microcontroller, a plurality of microcontrollers, a processor, or a plurality of processors.

The processing system 300 may be a standalone computer, a server, a console, or a network thereof. The processing system 300 and needed structural parts may be all inside device/apparatus such as IoT device/apparatus i.e. embedded to very small size.

In some example embodiments, the processing system 300 may also be associated with external software applications. These may be applications stored on a remote server device/apparatus and may run partly or exclusively on the remote server device/apparatus. These applications may be termed cloud-hosted applications. The processing system 300 may be in communication with the remote server device/apparatus in order to utilize the software application stored there.

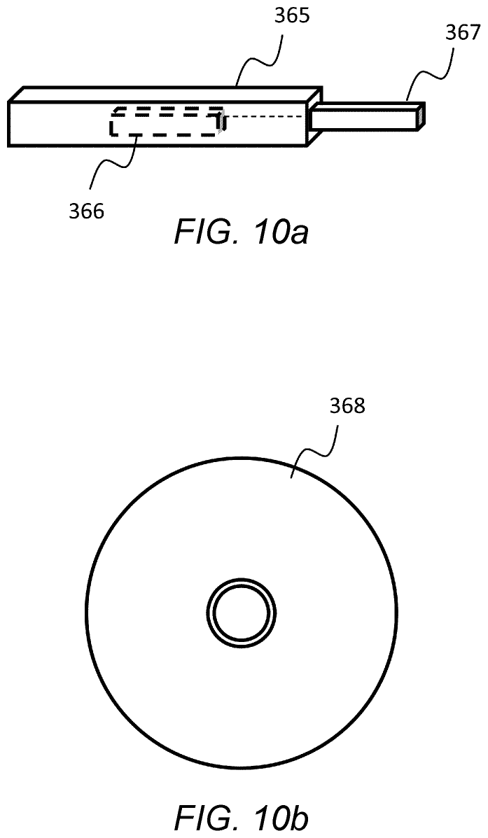

FIGS. 10A and 10B show tangible media, respectively a removable memory unit 365 and a compact disc (CD) 368, storing computer-readable code which when run by a computer may perform methods according to example embodiments described above. The removable memory unit 365 may be a memory stick, e.g. a USB memory stick, having internal memory 366 storing the computer-readable code. The internal memory 366 may be accessed by a computer system via a connector 367. The CD 368 may be a CD-ROM or a DVD or similar. Other forms of tangible storage media may be used. Tangible media can be any device/apparatus capable of storing data/information which data/information can be exchanged between devices/apparatus/network.

Embodiments of the present invention may be implemented in software, hardware, application logic or a combination of software, hardware and application logic. The software, application logic and/or hardware may reside on memory, or any computer media. In an example embodiment, the application logic, software or an instruction set is maintained on any one of various conventional computer-readable media. In the context of this document, a “memory” or “computer-readable medium” may be any non-transitory media or means that can contain, store, communicate, propagate or transport the instructions for use by or in connection with an instruction execution system, apparatus, or device, such as a computer.

Reference to, where relevant, “computer-readable medium”, “computer program product”, “tangibly embodied computer program” etc., or a “processor” or “processing circuitry” etc. should be understood to encompass not only computers having differing architectures such as single/multi-processor architectures and sequencers/parallel architectures, but is also specialised circuits such as field programmable gate arrays FPGA, application specify circuits ASIC, signal processing devices/apparatus and other devices/apparatus. References to computer program, instructions, code etc. should be understood to express software for a programmable processor firmware such as the programmable content of a hardware device/apparatus as instructions for a processor or configured or configuration settings for a fixed function device/apparatus, gate array, programmable logic device/apparatus, etc.

If desired, the different functions discussed herein may be performed in a different order and/or concurrently with each other. Furthermore, if desired, one or more of the above-described functions may be optional or may be combined. Similarly, it will also be appreciated that the flow diagrams of FIGS. 3, 5 and 7 are examples only and that various operations depicted therein may be omitted, reordered and/or combined.

It will be appreciated that the above described example embodiments are purely illustrative and are not limiting on the scope of the invention. Other variations and modifications will be apparent to persons skilled in the art upon reading the present specification.

Moreover, the disclosure of the present application should be understood to include any novel features or any novel combination of features either explicitly or implicitly disclosed herein or any generalization thereof and during the prosecution of the present application or of any application derived therefrom, new claims may be formulated to cover any such features and/or combination of such features.

Although various aspects of the invention are set out in the independent claims, other aspects of the invention comprise other combinations of features from the described example embodiments and/or the dependent claims with the features of the independent claims, and not solely the combinations explicitly set out in the claims.

It is also noted herein that while the above describes various examples, these descriptions should not be viewed in a limiting sense. Rather, there are several variations and modifications which may be made without departing from the scope of the present invention as defined in the appended claims.

1.-19. (canceled)

20. An apparatus comprising:
at least one processor; and
at least one memory storing instructions that, when executed by the at least one processor, causes the apparatus at least to:
provide a plurality of processed channel state information data to separate inputs of a multiple-input-multiple-output autoencoder, wherein each channel state information data of the plurality relates to communications between a user device and one of a plurality of communication nodes in communication with said user device; and
generate a co-ordinate code for the user device using said autoencoder.

21. The apparatus as claimed in claim 20, wherein the at least one memory and the instructions, when executed by the at least one processor, cause the apparatus to:
process said channel state information to generate said plurality of processed channel state information data.

22. The apparatus as claimed in claim 21, wherein processing said channel state information data includes generating moment matrices of said channel state information data.

23. The apparatus as claimed in claim 21, wherein processing said channel state information data includes normalizing said data.

24. The apparatus as claimed in claim 20, wherein the at least one memory and the instructions, when executed by the at least one processor, cause the apparatus to:
determine the channel state information data.

25. The apparatus as claimed in claim 20, wherein the autoencoder is a convolutional autoencoder.

26. The apparatus as claimed in claim 20, wherein said co-ordinate code is provided by a fully connected layer of the autoencoder.

27. The apparatus as claimed in claim 20, wherein the autoencoder is pre-trained.

28. The apparatus as claimed in claim 20, wherein the at least one memory and the instructions, when executed by the at least one processor, cause the apparatus to:
update trainable parameters of said autoencoder based on at least some of the plurality of processed channel state information data.

29. A method, comprising:
providing a plurality of processed channel state information data to separate inputs of a multiple-input-multiple-output autoencoder, wherein each channel state information data of the plurality relates to communications between a user device and one of a plurality of communication nodes in communication with said user device; and
generating a co-ordinate code for the user device using said autoencoder.

30. The method as claimed in claim 29, further comprising:
processing said channel state information to generate said plurality of processed channel state information data.

31. The method as claimed in claim 30, wherein processing said channel state information data includes generating moment matrices of said channel state information data.

32. The method as claimed in claim 30, wherein processing said channel state information data includes normalizing said data.

33. The method as claimed in claim 29, further comprising:
determining the channel state information data.

34. The method as claimed in claim 29, wherein the autoencoder is pre-trained.

35. The method as claimed in claim 29, further comprising:
updating trainable parameters of said autoencoder based on at least some of the plurality of processed channel state information data.

36. A non-transitory computer readable medium comprising program instructions stored thereon for performing at least the following:
providing a plurality of processed channel state information data to separate inputs of a multiple-input-multiple-output autoencoder, wherein each channel state information data of the plurality relates to communications between a user device and one of a plurality of communication nodes in communication with said user device; and
generating a co-ordinate code for the user device using said autoencoder.
